(19) United States
(12) Patent Application Publication
(10) Pub. No.: US 2024/0025587 A1
(43) Pub. Date: Jan. 25, 2024

(54) DEVICE AND METHOD FOR SEPARATELY-LOADING OBJECTS INTO PACKAGES

(71) Applicant: ABB Schweiz AG, Baden (CH)

(72) Inventors: Xibing Wang, Jiaozhou City, Qingdao (CN); Haoteng Lei, Shanghai (CN); Jianwei Liu, Shanghai (CN); Chuanfang Xiao, Shanghai (CN); Dilong Yu, Shanghai (CN)

(21) Appl. No.: 18/042,164

(22) PCT Filed: Aug. 19, 2020
(86) PCT No.: PCT/CN2020/110002

§ 371 Date: Feb. 17, 2023

(51) Int. Cl. B65B 35/06; B65B 35/36; B65B 57/12

(52) U.S. Cl. CPC B65B 35/06; B65B 35/36; B65B 57/12

(57) ABSTRACT

A device and a method for separately-loading objects into packages. The device includes a separating assembly adapted to separate the objects fetched from a hopper. The device also includes a first conveyor adapted to receive and transport the objects separated by the separating assembly, and a detecting assembly adapted to obtain detected data about the objects transported on the first conveyor. The device includes a controller adapted to determine tangling information indicating whether the objects are tangled together and to determine target objects to be loaded into the packages at least based on the tangling information. The device can also include a loading assembly adapted to load the target objects to the packages.

### FIELD

Embodiments of the present disclosure generally relate to a device and a method for separately-loading objects into packages.

### BACKGROUND

Packaging is an all-encompassing industry term for the technology and design work that will protect or enclose every sort of product destined for storage, shipping and sale. Packaging includes many processes: fabrication, cleaning, filling, sealing, combining, labeling, overwrapping, palletizing. Packaging is now done mainly through the use of packaging machinery. Packaging machinery is used throughout all packaging operations, involving primary packages to distribution packs, which play increasingly important roles.

For example, packaging machinery can improve labor productivity. One good example of this is a candy packing machine. Here, hundreds to thousands of candies can be wrapped in minutes. In addition, the packaging machinery can also reduce packaging costs and save storage costs for loose products, such as cotton, tobacco, silk, linen, etc., by simply using compression packaging. In food industries, packaging machinery can reliably ensure product hygiene by eliminating hand contact with food and medicines. An essential part of the packaging is how to fill or load goods or items in packages. However, due to shapes of goods or items to be packaged, for example, some goods or items cannot be filled or loaded into the package using packaging machinery automatically and need to be manually placed in the packages.

### SUMMARY

Embodiments of the present disclosure provide a device and a method for separately-loading objects into packages to at least in part solve the above and other potential problems.

In a first aspect, a device for separately-loading objects into packages is provided. The device for separately-loading objects into packages, comprising: a separating assembly adapted to separate the objects fetched from a hopper; a first conveyor adapted to receive and transport the objects separated by the separating assembly; a detecting assembly adapted to obtain detected data about the objects transported on the first conveyor; a controller adapted to determine tangling information indicating whether the objects are tangled together and to determine target objects to be loaded into the packages at least based on the tangling information; and a loading assembly adapted to load the target objects to the packages.

Within the separating assembly and the loading assembly, some kinds of objects prone to entanglement, and thus relying on manual packaging can be loaded into packages automatically. This is particularly advantageous for some industries, especially the food industry. Packaging efficiency can be significantly improved and product hygiene can be reliably ensured by eliminating hand contact. Furthermore, error loading can also be avoided through automatic loading.

In some embodiments, the controller is further adapted to determine the target objects if the tangling information indicates that the objects are not tangled together; determine position information of each of the target objects based on the detected data and a speed of the first conveyor; and control the loading assembly to load the target objects to the respective packages based on the position information. In this way, the pickup assembly can pick up the objects that are not tangled together accurately and quickly, further improving the packaging efficiency.

In some embodiments, the device further comprises a second conveyor arranged downstream of the first conveyor; and a plurality of discharging ports arranged downstream of the second conveyor and coupled to the respective packages. In this way, the second conveyor can provide a buffer for the objects to be loaded into packages, reducing the difficulty of control, and thus improving packaging accuracy.

In some embodiments, the second conveyor comprises a plurality of work ways associated with the respective discharging ports; and a plurality of dropping locations arranged along each of the plurality of work ways and the adjacent dropping locations spaced apart by a division member. This arrangement can improve efficiency for loading the objects into the packages.

In some embodiments, the loading assembly comprises at least one manipulator adapted to pick up the target objects from the first conveyor and to release the target objects to the respective dropping locations. This arrangement can efficiently prevent the objects from accidentally falling, further improving the reliability of the device.

In some embodiments, the controller is further adapted to determine the dropping locations for releasing the target objects according to a position of the at least one manipulator with respect to the second conveyor. As a result, the loading efficiency is further improved.

In some embodiments, the controller is further adapted to determine types of the target objects according to the detecting data; and determine the dropping locations for releasing the target objects according to the types. In this way, different types of objects can be loaded into corresponding packages, which expands the application scope of the device.

In some embodiments, the separating assembly comprises a first lifting apparatus coupled to the hopper and comprising at least two carrying partitions spaced apart at a predetermined distance to lift the objects from the hopper in batches; and a centrifugal apparatus adapted for centrifugal separation of the objects lifted by the first lifting apparatus. This arrangement can ensure separation of the objects as much as possible.

In some embodiments, the separating assembly further comprises a separating conveyor arranged between the centrifugal apparatus and the first conveyor and comprising at least two sections along a running direction, the at least two sections adapted to run at different speeds to further separate the objects. This can further ensure separation of the objects.

In some embodiments, the separating assembly further comprises a bidirectional vibration apparatus arranged between the centrifugal apparatus and the separating conveyor to further separate the objects with micro-motions in horizontal and vertical directions. The bidirectional vibration device can separate the objects efficiently.

In some embodiments, the first conveyor comprises an information acquisition region adapted for the detecting assembly to obtain the detected data; and a pickup region arranged downstream of the information acquisition region and adapted for the loading assembly to pick up the objects. In this way, the space layout of the device is more reasonable, and the space utilization rate is improved.

In some embodiments, the detecting assembly comprises a camera arranged over the information acquisition region and adapted to obtain images of the objects transported on the first conveyor regularly. In this way, the detecting data can be efficiently acquired and processed.

In some embodiments, the device further comprises a return conveyor arranged downstream of the first conveyor to receive and transport the objects that are not picked up to the hopper. This can increase the degree of automation of the device.

In some embodiments, the device further comprises a second lifting apparatus arranged downstream of the return conveyor and adapted to lift the objects transported by the return conveyor to the hopper.

In a second aspect, a method of separately-loading objects into packages is provided. The method comprises obtaining detected data about the objects transported on a first conveyor; determining tangling information of the objects indicating whether the objects are tangled together; determining target objects to be loaded into the packages at least based on the tangling information; and controlling at least one manipulator to load the target objects to the packages.

In some embodiments, the method further comprises obtaining a speed of the first conveyor; determining the target objects if the tangling information indicates the objects that are not tangled together; determine position information of the target objects based on the detected data and the speed of the first conveyor; and controlling the at least one manipulator to load the target objects to the respective packages based on the position information.

In some embodiments, the method further comprises determining dropping locations for releasing the target objects according to a position of the at least one manipulator with respect to a second conveyor through which the target objects are transported to the packages.

In some embodiments, the method further comprises determining types of the target objects according to the detecting data; and determining dropping locations for releasing the target objects according to the types.

It is to be understood that the Summary is not intended to identify key or essential features of embodiments of the present disclosure, nor is it intended to be used to limit the scope of the present disclosure. Other features of the present disclosure will become readily comprehensible through the description below.

### BRIEF DESCRIPTION OF THE DRAWINGS

The above and other objectives, features and advantages of the present disclosure will become more apparent through more detailed depiction of example embodiments of the present disclosure in conjunction with the accompanying drawings, wherein in the example embodiments of the present disclosure, the same reference numerals usually represent the same components.

FIG. 1 shows a top view of a device for separately-loading objects into packages according to embodiments of the present disclosure;

FIG. 2 shows a front view of a device for separately-loading objects into packages according to embodiments of the present disclosure; and

FIG. 3 shows a flowchart illustrating a method for separately-loading objects into packages according to embodiments of the present disclosure.

Throughout the drawings, the same or similar reference symbols are used to indicate the same or similar elements.

### DETAILED DESCRIPTION

The present disclosure will now be discussed with reference to several example embodiments. It is to be understood these embodiments are discussed only for the purpose of enabling those persons of ordinary skill in the art to better understand and thus implement the present disclosure, rather than suggesting any limitations on the scope of the subject matter.

As used herein, the term “comprises” and its variants are to be read as open terms that mean “comprises, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be comprised below. A definition of a term is consistent throughout the description unless the context clearly indicates otherwise.

As mentioned above, some goods or items, due to factors such as their shapes, cannot be filled or loaded into packages using packaging machinery such as an automatic loading device and need to be manually placed in the packages. For example, in the food industry such as the instant noodle processing industry or the like, forks usually need to be loaded into packages manually. This is because the forks are prone to entanglement. A conventional loading device cannot separate the tangled forks efficiently, which makes it difficult to load them into packages using the conventional loading device.

Furthermore, even if some forks can be separated from some other forks that are still tanged together, the conventional loading device cannot distinguish the tangled forks. As a result, the conventional loading device may load the forks that are tangled together into packages, also known as an error loading. The error loading is unacceptable due to both cost and user experience. Thus, the conventional packaging machinery is not up to the task of loading forks into packages, so that the forks can only be loaded into packages manually at present, which requires a lot of labor. In addition, the manual loading of forks brings a high error rate, which may affect the user experience. Furthermore, manual loading of forks may also cause hygiene problems.

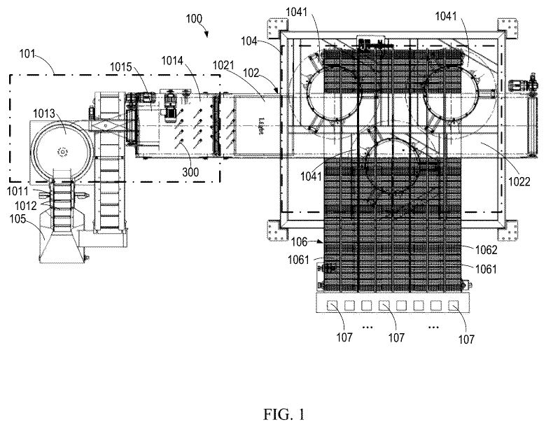

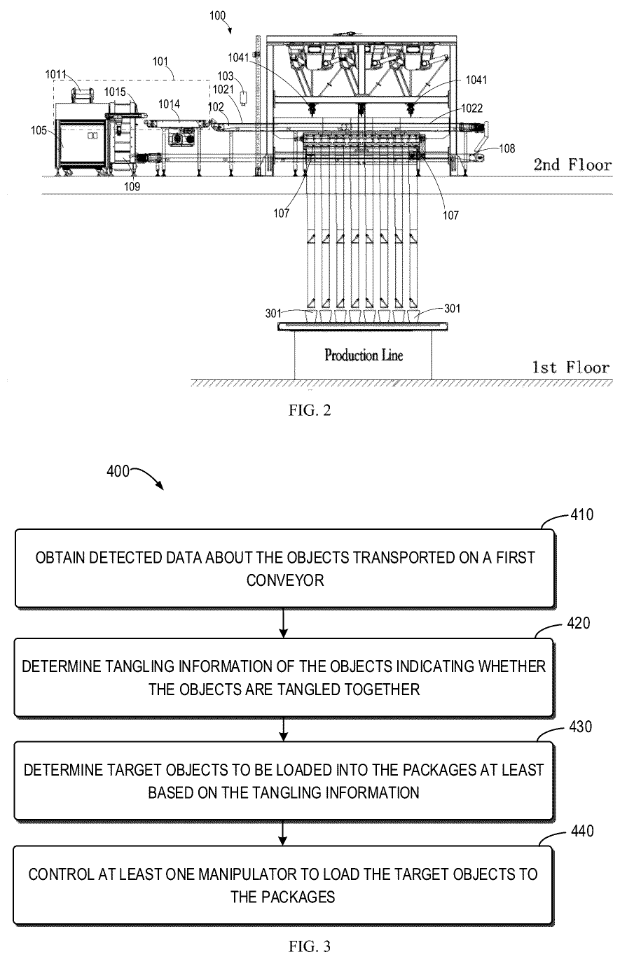

In order to at least partially address the above and other potential problems, embodiments of the present disclosure provide a device for separately-loading objects 300 such as forks or the like into packages. FIG. 1 shows a top view of a device for separately-loading objects 300 into packages, and FIG. 2 shows a front view of the device 100.

Generally, the device 100 comprises a separating assembly 101, a first conveyor 102, a detecting assembly 103, a controller and a loading assembly 104. The objects 300 to be loaded into the packages 301 are stored or placed in a hopper 105 arranged upstream of the device 100. The hopper 105 can be filled by appropriate means, for example, it can be automatically filled by communicating with a feeding unit. In some alternative embodiments, the hopper 105 can also be filled manually. The separating assembly 101 is adapted to fetch the objects 300 out of the hopper 105 and separate the fetched objects 300.

The first conveyor 102 is adapted to receive and transport the objects 300 separated by the separating assembly 101. In some embodiments, the first conveyor 102 can be driven by a servo motor. Using the servo motor can facilitate controlling of the first conveyor 102 and obtaining of speed thereof. It is to be understood that using a servo motor is merely for illustrative purposes, without suggesting any limitation as to the scope of the present disclosure. Other suitable driving means are also possible. For example, in some alternative embodiments, the first conveyor 102 may also be driven by an ordinary motor with an encoder.

Furthermore, in some embodiments, there are sensors arranged on the shaft of the motor to detect a rotation speed of the shaft. In this way, the speed of the first conveyor 102 can be determined based on the rotation speed. It is to be understood that this approach to determine the speed of the first conveyor 102 is merely for illustrative purposes, without suggesting any limitation as to the scope of the present application. Any other suitable arrangements or approach is also possible. For example, in some alternative embodiments, the speed of the first conveyor 102 can also obtained by speed sensors, infrared sensors, Hall sensors, etc.

During the transportation of the objects 300 along the first conveyor 102, the detecting assembly 103 can obtain detected data about the objects 300. In some embodiments, the first conveyor 102 may comprise two regions, one of which is an information acquisition region 1021 and another is a pickup region 1022 arranged downstream of the information acquisition region 1021. The detecting assembly 103 may obtain the detected data in the information acquisition region 1021. For example, in some embodiments, as shown in FIG. 2, the detecting assembly 103 may comprise a camera arranged over the information acquisition region 1021 to obtain images of the objects 300 transported on the first conveyor 102 regularly.

The images can be obtained every certain period of time, which can be related to a speed of the first conveyor 102 for transporting the objects 300. In some embodiments, the images obtained by the camera may be frames in a video. The camera may obtain a video about the objects 300 transported on the first conveyor 102. The controller may obtain the detected data by analyzing frames in the video regularly.

It is to be understood that the above embodiments where the detecting assembly 103 comprises a camera are merely for illustrative purposes, without suggesting any limitation as to the scope of the present disclosure. Any suitable means that can obtain the detected data to determine tangling information and position information are possible. For example, in some alternative embodiments, the detecting assembly 103 may comprise at least one of an infrared sensor, a distance sensor or the like.

The loading assembly 104 can pick up the target objects 300 in the pickup region 1022. In some embodiments, the loading assembly 104 may comprise at least one manipulator 1041. As shown in FIGS. 1 and 2, there are three manipulators illustrated as an example. The pickup range and release range of these three manipulators may have a certain overlap to ensure the reliability of the loading of objects 300. It is to be understood that the number and positions of the manipulator 1041 as shown in FIGS. 1 and 2 are merely for illustrative purposes, without suggesting any limitation as to the scope of the present disclosure. Other positions and/or numbers are also possible. For example, the loading assembly 104 may comprise one, two or more manipulators.

In some embodiments, the manipulator 1041 may be a delta robot arranged over the pickup region 1022, as shown in FIG. 2. The manipulator 1041 can pick up objects 300 in a predetermined range and release them to designated locations, which will be discussed further below. Of course, the delta robot as a manipulator 1041 is also illustrative, and is not intended to limit the scope of the present disclosure. Any other suitable manipulator 1041 capable of picking up and placing objects 300 is suitable. For example, in some alternative embodiments, industrial robots are also applicable.

The controller (not shown) is coupled to the detecting assembly 103 and can determine tangling information indicating whether the objects 300 are tangled together. In some embodiments, the controller for controlling the device 100 and the processor of the manipulator 1041 may be integrated. Of course, in some alternative embodiments, the controller and the processor of the manipulator 1041 may also be separate controllers.

At least based on the tangling information, the controller can determine target objects 300 to be loaded by the loading assembly 104 into the packages 301. With the device 100, on the one hand, the objects 300 can be efficiently separated by the separating assembly 101. On the other hand, even if a few objects 300 are not separated, the controller can distinguish the objects 300 that are not separated to prevent them from being loaded into the packages 301. In this way, the device 100 can automatically load objects 300 that are prone to entanglement into packages 301. For objects 300 that are not easily tangled, the device can more easily load them into packages 301. In other words, the device 100 can be applied to any suitable objects 300 that need to be loaded into packages 301, regardless of whether they are easily entangled.

Furthermore, as shown in FIG. 2, the packages 301 for receiving the objects 300 are also transported by a conveyor of a production line. When a batch of packages 301 arrive at respective predetermined positions, the controller can control the device 100 to load the objects 300 into the packages 301. The packages 301 with the objects 300 will then continue to move to the next positions and the subsequent batches of packages 301 will arrive at the predetermined position as mentioned above one after another. In this way, the automatic loading of objects 300 into packages 301 is realized with improved packaging efficiency. Furthermore, product hygiene can be reliably ensured by eliminating hand contact.

To separate the objects 300 efficiently, the separating assembly 101 employs various efficient means. Specifically, in some embodiments, the separating assembly 101 may comprise a first lifting apparatus 1011 and a centrifugal apparatus 1013. The first lifting apparatus 1011 is coupled to the hopper 105 and used to lift the objects 300 from the hopper 105. To this end, the first lifting apparatus 1011 comprises at least two carrying partitions 1012 spaced apart at a predetermined distance.

The carrying partitions 1012 may be arranged on a belt circulating between the hopper 105 and the centrifugal apparatus 1013. The belt may be driven by a motor or a servo motor. As the belt runs, some objects 300 inside the hopper 105 can be carried by the carrying partitions 1012 to the centrifugal apparatus 1013. The centrifugal apparatus 1013 may then be operated to separate the objects 300 by centrifugation.

After passing through the first lifting apparatus 1011 and the centrifugal apparatus 1013, most of the objects 300 can be separated. To further separate the objects 300 as much as possible, in some embodiments, the separating assembly 101 may also comprise a bidirectional vibration apparatus 1015 arranged at an output of the centrifugal apparatus 1013. The objects 300 separated by the centrifugal apparatus 1013 will be further separated by the bidirectional vibration apparatus 1015. The bidirectional vibration apparatus 1015 can provide micro-motions in horizontal and vertical directions to separate the objects 300. The micro-motions can separate objects 300 not separated by the centrifugal apparatus 1013 through low-noise vibration.

In some embodiments, the separating assembly 101 may also comprise a separating conveyor 1014 arranged between the centrifugal apparatus 1013 and the first conveyor 102.

In this event, the bidirectional vibration apparatus 1015 may be arranged between the centrifugal apparatus 1013 and the separating conveyor 1014. The separating conveyor 1014 comprises at least two sections along a running direction thereof. The at least two sections are adapted to run at different speeds to further separate objects 300. Specifically, in some embodiments, the downstream section of two adjacent sections is faster than the upstream section to increase the distance between the objects 300 during transportation from the bidirectional vibration apparatus 1015 to the first conveyor 102. In this way, the objects 300 can be further separated. Furthermore, in some embodiments, the speed of the first conveyor 102 is higher than or equal to the speed of the section of the separating conveyor 1014 adjacent to the first conveyor 102.

It can be seen from the above that in some embodiments, the separating assembly 101 performs three-stage separating. Specifically, the first lifting apparatus 1011 and the centrifugal apparatus 1013 perform a first stage separating; the bidirectional vibration apparatus 1015 performs a second stage separating and the separating conveyor 1014 performs a third stage separating. In this way, the objects 300 can be adequately separated. Even if there are a few objects 300 that are still not separated, the controller can distinguish them from the separated objects 300 to prevent the un-separated objects 300 from being loaded into packages 301.

Specifically, in some embodiments, the controller can determine the target objects 300 to be loaded into the packages 301 if the tangling information indicates that they are not tangled together. Furthermore, to control the manipulator 1041 to pick up the target objects 300, the controller needs to determine position information of each target object based on the detected data.

Because the pickup region 1022 is arranged downstream of the information acquisition region 1021 where the detected data is obtained, in some embodiments, to determine the position information, the speed of the first conveyor 102 is also needed. For example, the controller can determine the position information based on the detected data obtained in the information acquisition region 1021 and the speed of the first conveyor 102. With the position information, the controller can control the loading assembly 104, such as the manipulator 1041, to load the objects 300 to the respective packages 301.

To provide a buffer for the objects 300 to be loaded into packages 301 to efficiently prevent the objects 300 from being loaded into the wrong packages 301, in some embodiments, a second conveyor 106 may be arranged downstream of the first conveyor 102. For example, in some embodiments, as shown in FIG. 1, the second conveyor 106 may be run in a direction perpendicular to the first conveyor 102. Of course, this is just for illustrative purposes, and any other suitable arrangement is also possible. For example, the angle between the first and second conveyors 102, 106 may be between 0-90 degrees. With the second conveyor 106, the reliability of the loading objects 300 into packages 301 is further improved.

In some embodiments, a plurality of discharging ports 107 may be arranged downstream of the second conveyor 106 and coupled to the respective packages 301, as shown in FIGS. 1 and 2. For example, in some embodiments, the discharging ports 107 are vertically aligned with the packages 301 arriving at the predetermined positions where the objects 300 are loaded. Additionally and alternatively, there is a slide way between each pair of the discharging ports and the corresponding package 301. The slide ways can guide the objects 300 from the discharging ports to the respective packages 301 to ensure an accurate loading of objects 300 into packages 301.

In some embodiments, the second conveyor 106 may comprise a plurality of work ways 1061 associated with the respective discharging ports and a plurality of dropping locations 1062 along each work way. Adjacent dropping locations 1062 are spaced apart by a division member, which can facilitate the accurate release of the objects 300 on the second conveyor 106.

In some embodiments, the controller may determine the dropping locations 1062 for releasing the target objects 300 according to a position of the at least one manipulator 1041 with respect to the second conveyor 106. For example, the manipulator 1041 arranged on the left side of the second conveyor 106 in a running direction can be controlled to release the objects 300 on the work ways 1061 on the left. The manipulators 1041 arranged on the right side and the center position are similar to the above arrangement. This arrangement can avoid interference between manipulators 1041 to load the objects 300 accurately.

Furthermore, work ways 1061 where different manipulators 1041 release the objects 300 can be partially overlapped to avoid empty loading caused by untimely loading. In addition, as can be seen from FIG. 1, one of the manipulators 1041 is arranged downstream of the second conveyor 106 relative to the other two manipulators 1041. This arrangement can prevent empty loading and/or error loading. Specifically, the manipulator 1041 arranged downstream relative to the other manipulators 1041 can remedy possible errors caused by the manipulators 1041 arranged upstream, further improving the reliability of the device 100.

The controller may also determine types of the target objects 300 according to the detected data and determine the dropping locations 1062 for releasing the target objects 300 based on the types. In this way, the device 100 allows several different products, which correspond to different types of objects 300 to be loaded, to be produced on one production line. As a result, there is no need to prepare a dedicated production line for each product, thereby reducing costs. In some embodiments, the types of the target objects 300 can be determined by image analysis of the images acquired by the camera.

In some embodiments, the controller may also control the first speed of the first and second conveyors 102, 106, the separating assembly 101 and the manipulator 1041 to coordinate with the second speed of the conveyor for transporting packages 301. For example, the first speed is controlled so that the number of objects 300 transported through the first conveyor 102 is 10-20% more than the number required to load the packages 301 transported at the second speed. In this way, it can be ensured that each package can be loaded with an object, further improving the reliability of the device 100.

It is to be understood that the first speed as mentioned above does not imply that the first and second conveyors 102, 106, the separating assembly 101 and the manipulator 1041 have the same speed, but that the speeds of these components are coordinated so that they can supply objects 300 at a balanced speed. It is to be understood that the speeds of the above mentioned apparatuses can be obtained in a similar way to the method for obtaining or determining the speed of the first conveyor 102, which will not be repeated below.

Since the supplied quantity of the objects 300 is larger than the quantity required, there will always be objects 300 that are not eventually loaded into the packages 301, which may also comprise those that are tangled together but not separated. To reclaim these objects 300, in some embodiments, the device 100 may comprise a return conveyor 108 arranged downstream of the first conveyor 102, as shown in FIG. 2. The return conveyor 108 can receive and transport the objects 300 that are not picked up by the manipulator 1041 to the hopper 105. In this way, the automation level of the device 100 can be improved.

The return conveyor 108 may be arranged below the first conveyor 102. For those unpicked objects 300, they will fall on the return conveyor 108 due to gravity. In some embodiments, the device may comprise a guiding member arranged at a downstream end of the first conveyor 102, which can facilitate the falling of the objects 300 from the first conveyor 102 to the return conveyor 108.

In some embodiments, the device 100 may comprise a second lifting apparatus 109 arranged downstream of the return conveyor 108. The second lifting apparatus 109 can lift the objects 300 transported by the return conveyor 108 to the hopper 105. In this way, the objects 300 can be reused, increasing the degree of automation and saving costs.

According to another aspect of the present disclosure, a method of separate-loading objects 300 into packages 301 is provided. FIG. 3 shows a flowchart illustrating a method for separate-loading objects 300 into packages 301 according to embodiments of the present disclosure. The method can be implemented as program codes stored in a memory, which can be performed by the controller as mentioned above or any other suitable processor.

At block 410, the detected data about the objects 300 transported on the first conveyor 102 is obtained. Of course, it is to be understood that before this step, there may be a step of controlling the separating assembly 101 to lift and separate the objects 300 from the hopper 105. After the detected data is obtained, at block 420, the tangling information indicating whether the objects 300 are tangled together is determined.

At block 430, at least based on the tangling information, target objects 300 to be loaded into the packages 301 are determined. At block 440, the at least one manipulator 1041 is controlled to load the target objects 300 into the packages 301. In some embodiments, the target objects 300 may be determined if the tangling information indicates the objects 300 that are not tangled together.

In some embodiments, the speed of the first conveyor 102 may be obtained. Then the position information of the target objects 300 can be determined based on the detected data and the speed of the first conveyor 102. Based on the position information, the at least one manipulator 1041 is controlled to load the target objects 300 to the respective packages 301.

In some embodiments, dropping locations 1062 for releasing the target objects 300 may be determined according to a position of the at least one manipulator 1041 with respect to a second conveyor 106 through which the target objects 300 are transported to the packages 301. In some embodiments, the dropping locations 1062 may also be determined according to types of the objects 300, which can be determined according to the detected data.

It should be appreciated that the above detailed embodiments of the present disclosure are only to exemplify or explain principles of the present disclosure and not to limit the present disclosure. Therefore, any modifications, equivalent alternatives and improvements, etc. without departing from the spirit and scope of the present disclosure shall be comprised in the scope of protection of the present disclosure. Meanwhile, appended claims of the present disclosure aim to cover all the variations and modifications falling under the scope and boundary of the claims or equivalents of the scope and boundary.

1. A device for separately-loading objects into packages, comprising:
a separating assembly adapted to separate the objects fetched from a hopper;
a first conveyor adapted to receive and transport the objects separated by the separating assembly;
a detecting assembly adapted to obtain detected data about the objects transported on the first conveyor;
a controller adapted to determine tangling information indicating whether the objects are tangled together and to determine target objects to be loaded into the packages at least based on the tangling information; and
a loading assembly adapted to load the target objects into the packages.

2. The device of claim 1, wherein the controller is further adapted to:
determine the target objects if the tangling information indicates that the objects are not tangled together;
determine position information of each of the target objects based on the detected data and a speed of the first conveyor; and
control the loading assembly to load the target objects to the respective packages based on the position information.

3. The device of claim 1, further comprising:
a second conveyor arranged downstream of the first conveyor; and
a plurality of discharging ports arranged downstream of the second conveyor and coupled to the respective packages.

4. The device of claim 3, wherein the second conveyor comprises:
a plurality of work ways associated with the respective discharging ports; and
a plurality of dropping locations arranged along each of the plurality of work ways and the adjacent dropping locations spaced apart by a division member.

5. The device of claim 4, wherein the loading assembly comprises:
at least one manipulator adapted to pick up the target objects from the first conveyor and to release the target objects to the respective dropping locations.

6. The device of claim 5, wherein the controller is further adapted to determine the dropping locations for releasing the target objects according to a position of the at least one manipulator with respect to the second conveyor.

7. The device of claim 4, wherein the controller is further adapted to:
determine types of the target objects according to the detected data; and
determine the dropping locations for releasing the target objects according to the types.

8. The device of claim 1, wherein the separating assembly comprises:
a first lifting apparatus coupled to the hopper and comprising at least two carrying partitions spaced apart at a predetermined distance to lift the objects from the hopper in batches; and
a centrifugal apparatus adapted for centrifugal separation of the objects lifted by the first lifting apparatus.

9. The device of claim 8, wherein the separating assembly further comprises:
a separating conveyor arranged between the centrifugal apparatus and the first conveyor and comprising at least two sections along a running direction, the at least two sections adapted to run at different speeds to further separate the objects.

10. The device of claim 9, wherein the separating assembly further comprises:
a bidirectional vibration apparatus arranged between the centrifugal apparatus and the separating conveyor to further separate the objects with micro-motions in horizontal and vertical directions.

11. The device of claim 1, wherein the first conveyor comprises:
an information acquisition region adapted for the detecting assembly to obtain the detected data; and
a pickup region arranged downstream of the information acquisition region and adapted for the loading assembly to pick up the objects.

12. The device of claim 11, wherein the detecting assembly comprises:
a camera arranged over the information acquisition region and adapted to obtain images of the objects transported on the first conveyor regularly.

13. The device of claim 1, further comprising:
a return conveyor arranged downstream of the first conveyor to receive and transport the objects that are not picked up to the hopper.

14. The device of claim 13, further comprising:
a second lifting apparatus arranged downstream of the return conveyor and adapted to lift the objects transported by the return conveyor to the hopper.

15. A method of separately-loading objects into packages, comprising:
obtaining detected data about the objects transported on a first conveyor;
determining tangling information of the objects indicating whether the objects are tangled together;
determining target objects to be loaded into the packages at least based on the tangling information; and
controlling at least one manipulator to load the target objects to the packages.

16. The method of claim 15, further comprising:
obtaining a speed of the first conveyor;
determining the target objects if the tangling information indicates the objects that are not tangled together;
determine position information of the target objects based on the detected data and the speed of the first conveyor; and
controlling the at least one manipulator to load the target objects to the respective packages based on the position information.

17. The method of claim 15, further comprising:
determining dropping locations for releasing the target objects according to a position of the at least one manipulator with respect to a second conveyor through which the target objects are transported to the packages.

18. The device of claim 15, further comprising:
determining types of the target objects according to the detected data; and
determining dropping locations for releasing the target objects according to the types.

19. The device of claim 2, further comprising:
a second conveyor arranged downstream of the first conveyor; and
a plurality of discharging ports arranged downstream of the second conveyor and coupled to the respective packages.

20. The device of claim 5, wherein the controller is further adapted to:
determine types of the target objects according to the detected data; and
determine the dropping locations for releasing the target objects according to the types.
